(19) United States
(12) Patent Application Publication
(10) Pub. No.: US 2008/0281936 A1
(43) Pub. Date: Nov. 13, 2008

(54) SYSTEM AND METHOD FOR PUSHING SERVICE

(75) Inventors: Hua Li, Shenzhen (CN); Zhongxi Huang, Shenzhen (CN); Yan Zhao, Shenzhen (CN); Xuecheng Luo, Shenzhen (CN); Ruisheng Huang, Shenzhen (CN); Jue Liao, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Tencent Technology (Shenzhen) Company Ltd., Shenzhen (CN)

(21) Appl. No.: 12/134,897

(22) Filed: Jun. 6, 2008

Related U.S. Application Data
(63) Continuation of application No. PCT/CN2007/000142, filed on Jan. 15, 2007.

(30) Foreign Application Priority Data
Jan. 15, 2006 (CN) 200610033051.X

(51) Int. Cl. G06F 15/16

(52) U.S. Cl. 709/207

(57) ABSTRACT

A system for pushing a service utilizing Instant Messaging includes: a service pushing subsystem, adapted to send a service stored in the service pushing subsystem to a client subsystem through instant messages; the client subsystem, adapted to receive the service sent by the service pushing subsystem and display the service; wherein the service pushing subsystem is in a buddy list stored in the client subsystem. A method for pushing a service utilizing Instant Messaging includes: sending, by a service pushing subsystem, a service stored in the service pushing subsystem to a client subsystem through instant messages, wherein the service pushing subsystem is in a buddy list stored in the client subsystem; and receiving, by the client subsystem, the service sent by the service pushing subsystem and displaying the service. In accordance with the present invention, it is possible to implement the real-time interaction between the user and the service and improve the service efficiency and effect. Meanwhile, it is possible to utilize the large amount of IM users and increase the user amount of the service.

### FIELD OF THE INVENTION

The present invention relates to Instant Messaging (IM) fields, and more particularly, to a system and a method for pushing a service to a user utilizing Instant Messaging (IM).

### BACKGROUND OF THE INVENTION

Instant Messaging (IM) is an Internet-based communication service mainly for implementing instant communications on the Internet. The instant communication may be implemented between users by point-to-point communication technologies. At present, the IM technology has been widely applied and has a large amount of users. The users may implement the IM with each other via text, video or audio, etc. When a user desires to communicate with another user through the IM, he/she first adds the user to a buddy list to take the user as a buddy, and then selects the user from the buddy list, inputs messages and sends the messages to the user.

Along with the development of communication technologies, network operators or service providers are able to provide more and more kinds of services, e.g. TV program, ticket-ordering, hotel-ordering, e-shopping, etc. to the users by electronic modes. At present, such services are generally implemented by logging in particular websites, making a phone call or sending short messages. These implementation modes have poor real-time interaction performance and the efficiency and effect of the services can hardly be guaranteed.

### SUMMARY OF THE INVENTION

Embodiments of the present invention provides a system and a method for pushing a service utilizing Instant Messaging, so as to solve the problem of poor real-time interaction performance and low service efficiency and effect of the prior art, thereby improving the real-time interaction performance and service efficiency of the service.

In accordance with an embodiment of the present invention, the system for pushing a service utilizing the Instant Messaging includes:

A system for pushing a service utilizing Instant Messaging includes:
a service pushing subsystem, adapted to send a service stored in the service pushing subsystem to a client subsystem through instant messages;
the client subsystem, adapted to receive the service sent by the service pushing subsystem and display the service; wherein the service pushing subsystem is in a buddy list stored in the client subsystem.

In accordance with another embodiment of the present invention, the method for pushing a service utilizing the Instant Messaging includes:

A method for pushing a service utilizing Instant Messaging includes:
sending, by a service pushing subsystem, a service stored in the service pushing subsystem to a client subsystem through instant messages, wherein the service pushing subsystem is in a buddy list stored in the client subsystem; and
receiving, by a the client subsystem, the service sent by the service pushing subsystem and displaying the service.

In accordance with the embodiments of the present invention, it is possible to implement the real-time interaction between the user and the service and improve the service efficiency and effect. Meanwhile, it is possible to utilize the large amount of IM users and increase the user amount of the service. Embodiments of the present invention may be widely applied to services such as TV program, ticket-ordering, hotel-ordering and e-shopping.

### BRIEF DESCRIPTION OF DRAWINGS

FIG. 1 is a schematic diagram illustrating a structure of the system for pushing a service in accordance with an embodiment of the present invention.

FIG. 2 is a flowchart illustrating a method for pushing a service in accordance with an embodiment of the present invention.

### DESCRIPTION OF PREFERRED EMBODIMENTS

The present invention is described hereinafter in detail with reference to accompanying drawings and embodiments to make the objective, technical solution and merits thereof more apparent. It should be noted that the embodiments described herein are only for explaining the present invention and are not for limiting the protection scope of the present invention.

To solve the problem of the prior art, e.g. poor real-time interaction performance, lower service efficiency and poor effect, the pushing of the service is combined with the Instant Messaging (IM) technology. Thus, it is possible to provide more flexible and convenient service to the user and improve the real-time interaction performance between the user and the service, and it is also possible to utilize the large amount of IM users and increasing the user amount of the service.

An embodiment of the present invention provides a general system architecture applicable for various of services such as TV program, ticket-ordering, hotel-ordering and e-shopping.

To implement communication between the service pushing system and the user, the user needs to first add the service pushing system to a buddy list to take the service pushing system as an IM buddy. Then the communication between the user and the service pushing system may be implemented through instant messages between the user and the service pushing system.

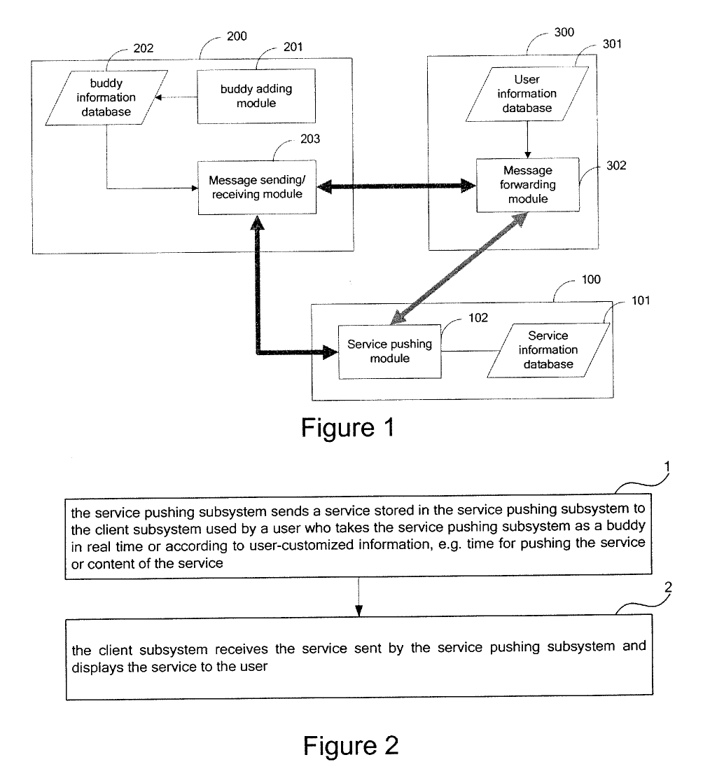

FIG. 1 is a schematic diagram illustrating a structure of the service pushing system in accordance with an embodiment of the present invention. For simplicity, only those related with the service pushing system in the embodiment of the present invention are shown.

In this embodiment, the service pushing system includes a service pushing subsystem 100, a client subsystem 200 and an IM service subsystem 300.

The service pushing subsystem 100 serves as a virtual IM user and has one or more IM identification codes. The main function of the service pushing subsystem 100 is to provide various kinds of services to users in real-time or according to user-customized information, e.g. time for pushing the service or content of the service customized by the user. The service may include TV program, ticket-ordering, hotel-ordering and c-shopping. Take the TV program as an example, it may include on-demand program and live program. The on-demand program may further include teleplays, movies and opusculums, and the live program may further include sports live, scene voting, intelligence test and beauty contest, etc. After the user adds the IM identification code corresponding to the service pushing subsystem 100 to the buddy list via the IM service subsystem 300, a point-to-point instant message interaction may be established between the service pushing subsystem 100 and the client subsystem 200 used by the user to implement the service interaction.

The client subsystem 200 is adapted to receive the service from the service pushing subsystem 100 and send instant messages including a service response to the service pushing subsystem 100. After the user successfully logs in the IM service subsystem 300 through the client subsystem 200, the client subsystem 200 may interact with the service pushing subsystem 100 if the service pushing subsystem 100 is in the buddy list of the user. As has been described above, if the service pushing subsystem 100 is not in the buddy list of the user, the user needs to select the IM identification code corresponding to the service pushing subsystem 100 and adds the IM identification code to the buddy list to take the service pushing subsystem 100 as a buddy, and then the user can interact with the service pushing subsystem 100.

The IM service subsystem 300 is adapted to store personal information of the user, such as IM identification code, password, user's name, and adapted to authenticate the user when the user logs in. The IM service subsystem 300 is further adapted to store buddy information of the user, establish a point-to-point connection between the client subsystem 200 and the service pushing subsystem 100 when a logged-in user needs to interact with the service pushing subsystem 100, assist the service pushing subsystem 100 with service pushing, receive and store the instant messages sent to the user by the service pushing subsystem 100 when the user is offline, and forward the instant messages to the user when the user logs in next time. For a user who has not added the service pushing subsystem 100 to his/her buddy list, the IM service subsystem 300 adds the service pushing subsystem 100 to the user's buddy list after receiving an add buddy request from the user for adding the service pushing subsystem 100 as a buddy, and assists the user to customize the service, e.g. customize the content and the time of the service through interaction with the client subsystem 200. In addition, the IM service subsystem 300 may further be adapted to monitor the instant messages sent by the service pushing subsystem 100 or monitor the service content pushed by the service pushing subsystem 100, so as to avoid the situation that the service pushing subsystem 100 sends instant messages to the user too frequently thereby affecting the user's service experience.

As shown in FIG. 1, the service pushing subsystem 100 includes a service database 101 and a service pushing module 102.

The service database 101 is adapted to store various kinds of services such as TV program, ticket-ordering, hotel-ordering and e-shopping as described above. The service stored by the service database 101 may be updated in real-time by TV stations or other service providers to provide latest real-time service to the user.

The service pushing module 102 is adapted to send, in real time or at the time customized by the user, the service stored in the service database 101 to the user who has added the service pushing subsystem to the buddy list, and adapted to receive the instant messages sent by the user through the client subsystem 200, and return instant messages to the client subsystem 200 after corresponding processing so as to implement the instant message interaction with the user.

For example, when the user's instant message is to order a teleplay, the service pushing module 102 queries the service database 101, sends multimedia data corresponding to the teleplay as instant messages to the client subsystem 200 or plays the teleplay for the user; when the content of the user's instant message is to scene vote, the service pushing module 102 stores user's vote into the service database 101, returns a message about whether the vote is successful and latest vote statistic result to the client subsystem 200.

Refer to FIG. 1, the client subsystem 200 includes a buddy adding module 201, a buddy information database 202 and a message sending/receiving module 203.

When the user selects to add the TIM identification code corresponding to the service pushing subsystem 100 into his/her buddy list, the buddy adding module 201 adds the service pushing subsystem 100 to the buddy information database 202 through the IM service subsystem 300. After that, the user may receive instant messages from the service pushing subsystem 100 via the message sending/receiving module 203, and send IM response messages to the service pushing subsystem 100 to interact with the service.

In the embodiment, the process for adding the service pushing subsystem 100 to the buddy information database 202 through the client subsystem 200 and the process for performing the instant message interaction with the service pushing subsystem 100 are respectively the same as the process for adding a buddy and the process for instant message interaction between traditional users, which are not repeated herein.

As shown in FIG. 1, the IM service subsystem 300 includes a user information database 301 and a message forwarding module 302.

The user information database 301 stores the buddy information and personal information of the user, e.g. the IM identification code, the password, the user's name. When the user logs in the IM service subsystem 300, the user information database 301 authenticates the user according to the personal information stored.

The message forwarding module 302 receives and stores the instant messages sent by the service pushing subsystem 100 when the user is offline, and forwards the instant messages stored to the user after the user logs in next time.

As can be seen from the above embodiments, service providers may provide more flexible and convenient service to the users and improve the real-time interaction performance between the user and the service, utilize the large amount of IM users and improve the user amount of the service by combining the IM technologies with service.

In accordance with another embodiment of the present invention, a method for pushing a service, as shown in FIG. 2, includes:
Step 1: the service pushing subsystem sends a service stored in the service pushing subsystem to the client subsystem used by a user who takes the service pushing subsystem as a buddy in real time or according to user-customized information, e.g. time for pushing the service or content of the service.
Step 2: the client subsystem receives the service sent by the service pushing subsystem and displays the service to the user.

The method may further include: the service pushing subsystem receives an instant message sent by the user, handles the instant message received and returns a handling result to the user via another instant message.

As described above, the service may include various kinds of services such as TV program, ticket-ordering, hotel-ordering and e-shopping.

In this embodiment, before the service pushing subsystem sends the service to the user, the method further includes a process of adding the service pushing subsystem as a buddy by the user. Specifically, the process includes: the user adds an IM identification code corresponding to the service pushing subsystem to his/her buddy list after logging in the IM service subsystem.

In this embodiment, the method may further include a step of updating the service stored in the service pushing subsystem by the service pushing subsystem according to the service provided by a service provider. Through the updating process, the service pushing subsystem may provide the latest service to the user in real time.

As can be seen from the above embodiments, the service provider may provide more flexible and convenient service to the user and improve the real-time interaction between the user and the service by combining the IM technologies with the pushing of the service.

The foregoing description is only preferred embodiments of the present invention and is not for use in limiting the protection scope thereof. Different modifications, equivalent replacements and improvements without departing from the spirit and scope of the present invention should be included in the protection scope of the present invention.

What is claimed is:

1. A system for pushing a service utilizing Instant Messaging (IM), comprising:
a service pushing subsystem, adapted to send a service stored in the service pushing subsystem to a client subsystem through instant messages;
the client subsystem, adapted to receive the service sent by the service pushing subsystem and display the service; wherein the service pushing subsystem is in a buddy list stored in the client subsystem.

2. The system of claim 1, wherein the client subsystem is further adapted to send a first instant message to the service pushing subsystem; and
the service pushing subsystem is further adapted to receive the first instant message from the client subsystem, handle the first instant message received and return a handling result to the client subsystem via a second instant message.

3. The service pushing system of claim 1, wherein the service pushing subsystem further comprises:
a service database, adapted to store the service; and
a service pushing module, adapted to query the service database in real-time or at a user-customized time, and send the service to the client subsystem.

4. The service pushing system of claim 2, wherein the service pushing subsystem further comprises:
a service database, adapted to store the service; and
a service pushing module, adapted to query the service database in real-time or at a user-customized time, and send the service to the client subsystem.

5. The service pushing system of claim 1, wherein the client subsystem further comprises:
a buddy information database, adapted to store buddy information; and
a message sending/receiving module, adapted to receive the service sent by the service pushing subsystem and send instant messages to the service pushing subsystem.

6. The service pushing system of claim 2, wherein the client subsystem further comprises:
a buddy information database, adapted to store buddy information; and
a message sending/receiving module, adapted to receive the service sent by the service pushing subsystem and send instant messages to the service pushing subsystem.

7. The system of claim 5, wherein the client subsystem further comprises:
a buddy adding module, adapted to add the service pushing subsystem to a buddy list according to an IM identification code of the service pushing subsystem, and submit information of the service pushing subsystem to the buddy information database for storage.

8. The system of claim 6, wherein the client subsystem further comprises:
a buddy adding module, adapted to add the service pushing subsystem to a buddy list according to an IM identification code of the service pushing subsystem, and submit information of the service pushing subsystem to the buddy information database for storage.

9. The system of claim 1, further comprising:
an IM service subsystem, adapted to store personal information and buddy information of a user using the client subsystem, authenticate the user when the user logs in the IM service subsystem through the client subsystem according to the personal information of the user, return the personal information and the buddy information of the user to the client subsystem after the user logs in, and establish a point-to-point connection between the client subsystem and the service pushing subsystem.

10. The system of claim 9, wherein the IM service subsystem further comprises:
a user information database, adapted to store the personal information and the buddy information of the user.

11. The system of claim 10, wherein the IM service subsystem further comprises:
a message forwarding module, adapted to store an instant message sent by the service pushing subsystem to the client subsystem when the user is offline and forward the instant message to the user when the user is online, and adapted to store an instant message sent by the user using the client subsystem to the service pushing subsystem and forward the instant message to the service pushing subsystem when the service pushing subsystem is online.

12. The system of claim 1, wherein the service comprises any one or any combination of TV program, ticket-ordering, hotel-ordering and e-shopping.

13. The system of claim 12, wherein the TV program comprises live program and/or on-demand program.

14. A method for pushing a service utilizing Instant Messaging (IM), comprising:
sending, by a service pushing subsystem, a service stored in the service pushing subsystem to a client subsystem through instant messages, wherein the service pushing subsystem is in a buddy list stored in the client subsystem; and
receiving, by a the client subsystem, the service sent by the service pushing subsystem and displaying the service.

15. The method of claim 14, wherein service pushing subsystem sends the service to the client subsystem in real time or according to user customized information; and the user-customized information comprises time for pushing the service or content of the service customized by a user using the client subsystem.

16. The method of claim 14, further comprising:
receiving, by the service pushing subsystem, a first instant message sent by the client subsystem, handling the first instant message received and returning a handling result to the client subsystem via a second instant message.

17. The method of claim 14, further comprising:
before the service pushing subsystem sends the service to the client subsystem, adding, by the client subsystem, an IM identification code corresponding to the service pushing subsystem to the buddy list.

18. The method of claim 14, further comprising:
updating, by the service pushing subsystem, the service stored in the service pushing subsystem according to the service provided by a service provider.

19. The method of claim 14, wherein the service comprises any one or any combination of TV program, ticket-ordering, hotel-ordering and e-shopping.

20. The method of claim 18, wherein the service comprises any one or any combination of TV program, ticket-ordering, hotel-ordering and e-shopping.

21. The service pushing method of claim 19, wherein the TV program comprises live program and/or on-demand program.

22. The service pushing method of claim 20, wherein the TV program comprises live program and/or on-demand program.

23. A client subsystem for receiving a service utilizing Instant Messaging, comprising:
a buddy information database, adapted to store buddy information of a user using the client subsystem;
a message sending/receiving module, adapted to receive a service sent by a service pushing subsystem and send instant messages to the service pushing subsystem; and
a buddy adding module, adapted to add the service pushing subsystem to a buddy list according to an IM identification code of the service pushing subsystem, and submit information of the service pushing subsystem to the buddy information database for storage.
